(19) United States
(12) Patent Application Publication
(10) Pub. No.: US 2009/0235673 A1
(43) Pub. Date: Sep. 24, 2009

(54) DETECTION OF REFRIGERANT RELEASE IN CO2 REFRIGERANT SYSTEMS

(76) Inventors: Alexander Lifson, Manlius, NY (US); Michael F. Taras, Fayetteville, NY (US)

Correspondence Address: CARLSON, GASKEY & OLDS, P.C., 400 WEST MAPLE ROAD, SUITE 350, BIRMINGHAM, MI, 48009, US

(21) Appl. No.: 12/375,236

(22) PCT Filed: Oct. 31, 2006
(86) PCT No.: PCT/US06/42340

§ 371 Date: Jan. 27, 2009

(51) Int. Cl. F25D 3/00; F25B 1/00; G01K 13/00

(52) U.S. Cl. 62/56; 62/498; 62/129

(57) ABSTRACT

A refrigerant system utilizes environmentally friendly natural refrigerant such as carbon dioxide. A pressure relief mechanism such as pressure relief valve is incorporated into the refrigerant system design to allow for at least some amount of refrigerant to be released to atmosphere to provide safe operation or comply with agency regulations if pressure within the refrigerant system exceeds a certain limit. This release can occur during refrigerant system storage, transportation or operation. A detection device such as an electrical circuit is included into the refrigerant system design to provide an indication that pressure relief valve has opened, such that the determination can be made by a refrigerant system control or an operator whether the refrigerant system needs to be recharged and whether it can continue its normal operation, narrow its operational envelope or shut down until the refrigerant charge can be restored.

### BACKGROUND OF THE INVENTION

This application relates to a refrigerant system charged with an environmentally benign refrigerant, such as CO₂, and having an identification device in place to detect when an overpressurization of a refrigerant system has caused release of at least some amount of refrigerant to the environment.

Refrigerant systems are known, and are utilized to condition indoor environments by maintaining the temperature and/or humidity of a secondary fluid within the required tolerance band or specification. As a common example, an air conditioning system cools/dehumidifies air to be delivered into a climate controlled indoor environment.

Historically, refrigerant systems have operated in the subcritical range and utilized hydrochlorofluorocarbons (HCFCs), such as R22, and more commonly hydrofluorocarbons (BFCs), such as R134a, R410A and R407C (so-called Freons) as refrigerants. Although BFC refrigerants are more environmentally friendly than the chlorine containing HCFC refrigerants that they replaced, “natural” refrigerants, such as carbon dioxide (also referred to as CO₂ or R744), are being turned to for use in air conditioning and refrigeration systems instead of HFC refrigerants and potentially will be mandated by legislation and industry regulations in some geographical regions in the near future.

CO₂ is a natural refrigerant which has shown good performance potential for various classes of applications, such as commercial refrigeration, heat pumps, water heaters, bottle coolers, display cases, container units, environmental control units, etc. Since CO₂ can be found in ambient air, it can naturally be released to the environment with no harm to the Earth's atmosphere. This fact significantly simplifies handling procedures of CO₂ and, in many cases, eliminates the necessity of refrigerant reclaim equipment.

CO₂ is a high pressure refrigerant and, pressures inside the system may reach extremely high levels, especially during operation, storage or transportation at high ambient temperatures. Therefore, it would be natural to incorporate various types of pressure relief means (e.g. a pressure relief valve, a burst disk, etc.) to prevent CO₂ refrigerant system overpressurization that could create safety hazard situations or damage system components. Since the CO₂ presents no harm to the environment (as is not the case with other commonly used refrigerants), at least a portion of a CO₂ refrigerant charge can be simply released into the environment, should a pressure relief valve be actuated by an unduly high pressure.

While the release of CO₂ into the environment raises no environmental concerns in general, it does effect the operation of the refrigerant system. After the release of at least some amount of the CO₂ charge, the refrigerant system would have a suboptimal charge amount. This can affect the performance (capacity and efficiency) of the refrigerant system, and undesirably raise the temperature of the components that are cooled by the refrigerant. As an example, the compressor and its motor are often cooled by the refrigerant and if there is an undesirably low charge, and consequently low circulation rate of the refrigerant, the inadequate cooling may affect compressor reliability or potentially cause the component damage.

Therefore, it is desirable to provide an identification device for the CO₂ refrigerant release detection.

### SUMMARY OF THE INVENTION

In disclosed embodiments of this invention, devices are provided to detect the release of a refrigerant to the environment during operation, storage or transportation. These devices may include a pressure relief valve, a burst disk, etc., to provide an indication that there may be an undesirably low charge of refrigerant in the system. Further steps can then be taken to add refrigerant charge or to limit system operation to a narrower and safer envelope until required maintenance is performed, to prevent component damage or compromise refrigerant system reliability.

In one disclosed embodiment, an indicator alarm such as sound or light would be turned on if, for instance, the pressure relief valve were actuated. In another embodiment, a control may stop operation of the compressor motor or limit compressor operation to a narrower envelope where the reduced refrigerant charge may still be sufficient to resume acceptable operation.

The indicator or the control may be actuated by a change of one of the characteristics of an electrical circuit connected to the pressure relief subsystem. For instance, the wire or a disk may be permanently broken or electrical contacts may be connected or disconnected due to pressure exerted by the released CO₂ flow, as well as a pressure relief valve may temporarily activate an electric signal during a refrigerant release time interval.

In yet another embodiment, if the ambient temperature or refrigerant pressure is measured during storage or transportation, the amount of released refrigerant can be closely estimated. Similarly, if the ambient temperature and the high-side refrigerant pressure or temperature are measured during operation, the charge amount that needs to be replenished can be approximated. Additionally, the release time interval can be measured to enhance the detection of refrigerant release.

These and other features of the present invention can be best understood from the following specification and drawings, the following of which is a brief description.

### BRIEF DESCRIPTION OF THE DRAWINGS

FIG. 1 is a schematic view of the refrigerant system incorporating the present invention.

FIG. 2 shows an alternative embodiment.

### DETAILED DESCRIPTION OF THE PREFERRED EMBODIMENTS

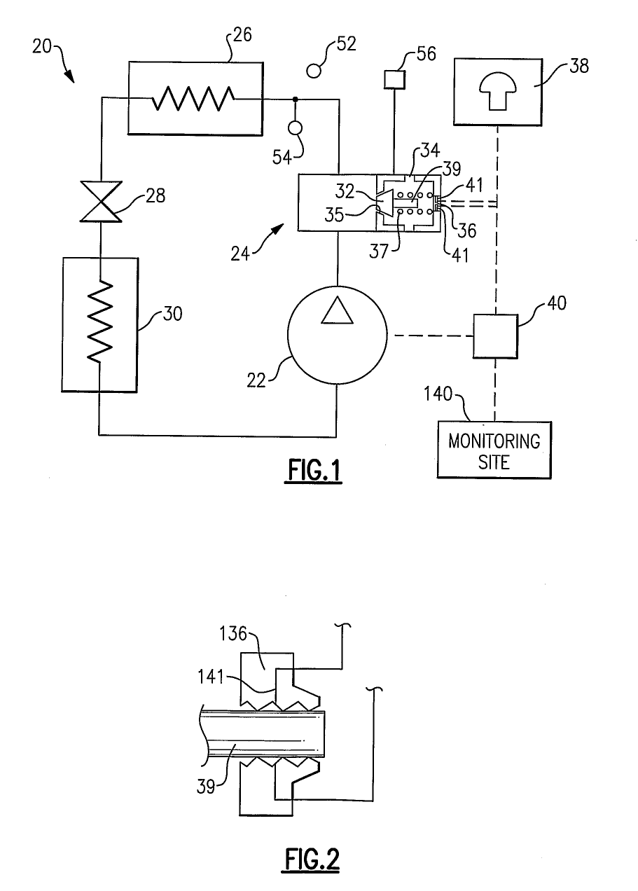

A basic refrigerant system 20 incorporates a compressor 22 delivering compressed refrigerant downstream, through a pressure relief valve assembly 24, into a heat rejecting heat exchanger 26, through an expansion device 28, to an evaporator 30 and back to the compressor 22. The refrigerant system 20 operates with an environmentally friendly natural refrigerant, such as carbon dioxide (also known as CO₂ or R744). Further, the refrigerant system 20 depicted in FIG. 1 is a basic refrigerant system, and many options and features could be added to the system schematic to enhance performance and reliability. All these configurations are within the scope and can equally benefit from the present invention. As known, the heat rejecting heat exchanger 26 could serve as a condenser in subcritical operation or as a gas cooler in transcritical operation.

Also, as known, the pressure relief valve assembly 24 is a safety device and allows the release of at least a portion of refrigerant to the environment in the event of overpressurization. This can be accomplished by different devices, such as a mechanically actuated valve, an electrically actuated valve, a burst disk, etc. For instance, in the embodiment shown in FIG. 1, a pressure relief valve 32 is moved to an open position when refrigerant pressure exceeds a safety limit and allows at least a portion of refrigerant to be released to an ambient environment or to atmosphere to maintain the refrigerant pressures within the safety limits. This provides a simple, failsafe way of preventing damage to system components, complying with agency requirements and avoiding potential injuries, should the pressure within the refrigerant pressure in the system ever exceed predetermined safety limits. This can occur during system operation, storage or transportation at high ambient temperatures or due to the accidental system overcharge. Carbon dioxide, being a high pressure refrigerant, is quite susceptible to overpressurization events.

As shown schematically, in an exemplary embodiment of FIG. 1, a valve member 32, which is initially in contact with a valve seat 35, provides a tight seal for refrigerant contained within the refrigerant system 20. The valve member 32 may be driven away from the valve seat 35 to allow pressure relief in the event of the refrigerant pressure within the refrigerant system 20 exceeding the predetermined safety limit. Since the valve 32 depicted in FIG. 1 is a mechanically actuated valve, the refrigerant pressure must overcome, for example, a spring force, exerted on the valve member 32 by a spring 37 and acting in an opposite direction, to allow the release of at least a portion of the refrigerant contained in the refrigerant system 20 and subsequent pressure reduction within the refrigerant system 20 to a level below the predetermined safety limit. As known, other arrangements can be utilized in place of the spring 37. For instance, a gas pressure force or a magnetic force can be used to counteract the refrigerant pressure. All these designs are within the scope and can equally benefit from the present invention.

During a time interval when the valve member 32 is moved away from the valve seat 35, the refrigerant is released through openings 34 to the ambient environment or atmosphere. Further, shown schematically in this Figure, the valve member 32 has a plunger portion 39 which can contact or pierce an element 36. The plunger portion 39 could, as an example, simply close an electric circuit by connecting two spaced electrical contacts 41. As shown in FIG. 2, the plunger 39 could also puncture a membrane 136 to cause a change, for instance, in electrical characteristics of the membrane 136 structure, such as breaking a wire 141. Any of several other possible ways of providing an electrical indication that the valve member 32 has moved away from it's the valve seat 35 allowing for at least partial refrigerant release can be used.

Further, the valve member 32 could be, for instance, electrically actuated based on pressure measurement within the system. Also, other means of refrigerant pressure relief (rather than the valve) such as a burst disk can be employed. All these variations are within the scope of the present invention.

When an opening of the valve member 32 has detected, an indication such as a light source or buzzer 38 may be actuated and/or a warning message may be issued. For instance, as a result, a maintenance request could be sent out. The opening of the valve can also be detected by displaying this event on a screen such, for example, a computer monitor, or via a text message, e-mail, etc. This is shown schematically by a link to a remote monitoring site 140. The link to a display could be hardwired, wireless or sent over the Internet.

In another embodiment, since low refrigerant charge may cause damage to the components of the refrigerant system 20 such as the compressor 22 (e.g. low refrigerant flow may not provide adequate cooling to the compressor motor and compression elements), a control 40 for the refrigerant system 20 may stop a motor for the compressor 22 until the system 20 is recharged with refrigerant to an appropriate level. Alternatively, a special diagnostic procedure may be executed to find out how much refrigerant is released to the atmosphere. Such diagnostic procedure could be performed on both a non-operating and an operating system. The procedure can be based on temperature and pressure sensor readings and is known in the art. One of the outcomes of this diagnostic procedure may be a narrower allowable operating envelope for a refrigerant system 20 until the refrigerant charge is replenished.

In yet another embodiment, if certain operational characteristics and environmental parameters are monitored and recorded during the refrigerant release, a determination can be made whether the refrigerant system 20 still has a sufficient amount of charge left for proper operation. For instance, if an ambient temperature sensor 52 or refrigerant pressure sensor 54 are incorporated into the system design, the corresponding ambient temperature or refrigerant pressure measured during storage or transportation can provide close approximation of the amount of released refrigerant, and then a determination can be made whether the refrigerant system 20 can continue normal operation, narrow its operational envelope or has to be shut down. Similarly, if the ambient temperature is measured by the temperature sensor 52 and the high-side refrigerant pressure or temperature is measured by the sensor 54 during operation when the refrigerant release occurs, the released charge amount can be estimated. Analogous conclusions can be made, if the release time interval (the time interval during which the valve member 34 is open) measured by the timer 56 and the ambient temperature and/or refrigerant pressure or temperature are monitored and recorded. These estimates are based on the facts that the closing pressure for the valve member 32 and the flow resistance coefficient of the valve seat 35 are known.

Therefore, the present invention provides a very simple and reliable method of providing an indication when a pressure relief valve has opened to allow at least some amount of the CO₂ charge to be released to the atmosphere. In this manner, operation of the refrigerant system 20 with an insufficient charge amount and potential component damage or reliability problems will be prevented.

It should be noted that this invention is not limited to the system shown in FIG. 1, the actual system may include additional components such as, for example, a liquid suction heat exchanger, a reheat coil, an intercooler, an economizer heat exchanger or a flash tank. The compressor may be a multi-stage compressor with separate compression stages connected in series. The compression device can also be represented by multiple compressors arranged in tandem, or installed on separate circuits in a multi-circuit refrigerant system. The idea would also apply to a broad range of refrigerant systems, for example, including container refrigeration systems, truck-trailer refrigeration systems, air conditioning and/or heat pump systems, rooftop units, supermarket installations, etc.

While a preferred embodiment of this invention has been disclosed, a worker of ordinary skill in the art would recognize that certain modifications would come within the scope of this invention, for that reason the following claims should be studied to determine the true scope and content of this invention.

1. A refrigerant system comprising:
a compressor compressing refrigerant and delivering refrigerant downstream to a heat rejecting heat exchanger, through an expansion device, through a heat accepting heat exchanger, and back to the compressor; and
the refrigerant utilized in said refrigerant system being an environmentally friendly refrigerant and there being a pressure relief member for allowing for at least a portion of refrigerant to be released to the atmosphere in the event of a pressure within the refrigerant system exceeding a predetermined safety limit, and there being a system for detecting the opening of the pressure relief member and providing an indication of refrigerant release.

2. The refrigerant system as set forth in claim 1, wherein the pressure relief member is one of a mechanically actuated valve, an electrically actuated valve, a burst disk and a membrane.

3. The refrigerant system as set forth in claim 1, wherein the pressure relief member is a valve and said valve is returned to its original position when the pressure within the refrigerant system is relieved to reach a predetermined safety limit.

4. The refrigerant system as set forth in claim 1, wherein the detection system is at least one of electric circuit, a visual indicator and a sound indicator.

5. The refrigerant system as set forth in claim 4, wherein the detection system is a visual indicator, and the visual indicator is at least one of a light source, a monitor display and an electronically generated message.

6. The refrigerant system as set forth in claim 1, wherein the pressure relief member includes a valve member that will change at least one characteristic of an electric circuit to provide the indication of the refrigerant release.

7. The refrigerant system as set forth in claim 6, wherein a valve member completes the electric circuit by connecting two circuit contacts.

8. The refrigerant system as set forth in claim 6, wherein the valve member punctures a membrane to provide the indication of the refrigerant release.

9. The refrigerant system as set forth in claim 1, wherein the environmentally friendly refrigerant is carbon dioxide.

10. The refrigerant system as set forth in claim 1, wherein refrigerant system sensors provide a determination of the amount of refrigerant released.

11. The refrigerant system as set forth in claim 10, wherein the refrigerant system sensors include at least one of an ambient temperature sensor, a high side refrigerant pressure sensor, a high side refrigerant temperature sensor and a timer.

12. The refrigerant system as set forth in claim 10, wherein a control can determine whether the refrigerant system can resume normal operation, narrow its operating envelope or needs to be shutdown until the refrigerant charge is replenished.

13. The refrigerant system as set forth in claim 1, wherein the refrigerant release detection is provided during at least one of operation, storage and transportation.

14. The refrigerant system as set forth in claim 1, wherein conditions of the refrigerant release are recorded and stored.

15. The refrigerant system as set forth in claim 14, wherein the conditions of the refrigerant release include at least one of environmental parameters, operational characteristics and the time of the release.

16. A method of operating a refrigerant system comprising the steps of:
providing a compressor compressing refrigerant and delivering refrigerant downstream to a heat rejecting heat exchanger, through an expansion device, through a heat accepting heat exchanger, and back to the compressor; and
the refrigerant utilized in said refrigerant system being an environmentally friendly refrigerant and there being a pressure relief member for allowing for at least a portion of refrigerant to be released to the atmosphere in the event of a pressure within the refrigerant system exceeding a predetermined safety limit, and there being a system for detecting the opening of the pressure relief member and providing an indication of refrigerant release.

17. The method as set forth in claim 16, wherein the pressure relief member is a valve and said valve is returned to its original position when the pressure within the refrigerant system is relieved to reach a predetermined safety limit.

18. The method as set forth in claim 16, wherein the detection system provides at least one of a visual indication and an audio indication.

19. The method as set forth in claim 16, wherein the pressure relief member includes a valve member that changes at least one characteristic of an electric circuit to provide the indication of the refrigerant release.

20. The method as set forth in claim 19, wherein a valve member completes the electric circuit by connecting two circuit contacts.

21.-28. (canceled)
